(19) United States
(12) Patent Application Publication
(10) Pub. No.: US 2015/0292538 A1
(43) Pub. Date: Oct. 15, 2015

(54) Panel Fastener with Adjustable, Biasing Cap Holder

(71) Applicant: Penn Engineering & Manufacturing Corp., Danboro, PA (US)

(72) Inventor: Yi He, Jiangsu (CN)

(21) Appl. No.: 14/683,466

(22) Filed: Apr. 10, 2015

Related U.S. Application Data
(60) Provisional application No. 61/977,934, filed on Apr. 10, 2014.

(51) Int. Cl. F16B 5/02; F16B 39/02

(52) U.S. Cl. CPC F16B 5/0208; F16B 39/02

(57) ABSTRACT

A panel fastener includes an internal spring clip held within a groove in the inside wall of the fastener cap, which engages a retainer to hold an extendable fastener at different positions on the retainer. The retainer can have contours and regions of reduced diameter that bear against the clip that establish positions of greater resistance to, or bias toward, movement of the fastener. The panel fastener makes it possible for the capped fastener to stay in different positions between its two end limit positions with reliable stability and without the need for any external sacrificial parts to meet the needs of pick-and-place automation. The fastener can be a screw or a non-threaded component.

### RELATED APPLICATION

This non-provisional patent application claims priority to provisional patent application No. 61/977,934 entitled “Panel Fastener Cap Holder” filed on Apr. 10, 2014, the contents of which are incorporated herein by reference.

### FIELD OF THE INVENTION

The present invention relates to panel fasteners having a retractable screw and a retainer. More specifically, it relates to panel fasteners of this type used in a pick-and-place assembly process.

### BACKGROUND OF THE INVENTION

Panel fasteners are typically composed of a screw, a cap affixed to the screw, a retainer and a spring such as sold by Penn Engineering and Manufacturing Corp. under the trademarks PEM® PF11 series and PF50 series panel fasteners. The screw/cap combination is moveable within the retainer between retracted and extended positions. Typically, the capped screw is designed either to stay in the retracted position before the screw is tightened or always be in a fixed extended position. In modern practice, there is a demand to have control of the cap position to achieve smaller panel space design, for compact and easy transportation, and to meet surface mount pick-and-place process stability requirements. Prior art designs that do not allow the cap to be held in the compressed/extended position before the screw is tightened have limited applications.

One prior art device utilizes a rubber ring or steel nut affixed on the screw thread that bears against the retainer to hold the cap and screw in an extended position. This design achieves part stability for the surface mount pick and place process. The disadvantage of this solution is not only the cost of installing the rubber ring or nut, but also the cost of disposing the rubber ring or nut after installation. Furthermore, the extended cap stay position is not repeatable thereafter without reassembly. Therefore, it would be desirable to provide a panel fastener that can hold the screw in the extended or other intermediate positions and requires no sacrificial components or requires reassembly of a sacrificial component to reconfigure the screw position.

### SUMMARY OF THE INVENTION

The invention provides a new way to control the static, at-rest position of the panel fastener cap, and hence the screw affixed thereto. According to one embodiment of the invention, an internal spring clip is utilized that is held within a groove in the inside wall of the cap, which also engages the retainer at different positions. The retainer can have contours and regions of reduced diameter, which bear against the clip and establish positions of greater resistance to, or bias toward, movement of the cap and fastener. The inventive panel fastener makes it possible for the capped screw to stay in different positions between its two end limit positions with reliable stability and without the need for any external sacrificial parts. This capability expands the number applications in which the present panel fastener can be used. Optionally, the screw can be replaced with other fasteners such as a non-threaded pin.

Generally speaking, one embodiment of the panel fastener is composed of a screw, a retainer that has areas of reduced diameter, two-part cap, and a non-circular resilient clip. The retainer has a central, axial bore through which the screw is moveable between retracted and extended positions. The clip is held in a groove within the inner wall of the cap. This construction allows the clip to frictionally grasp the retainer in the radial direction while permitting movement in the axial direction.

In a preferred embodiment, the screw cap is composed of an upper and a lower portion. The two parts are bonded together with a partial gap there between such that a groove is formed between the upper and lower portions along the cap inner wall. The clip is seated in the groove. As further described herein, the clip is non-circular and has portions of greater (major) and lesser (minor) dimensions measured from the center of the clip. The clip is resilient and is dimensioned such that the inside edge of the lesser diameter portions of the clip resiliently engage and clamp the retainer while portions of the clip of greater diameter are held in the groove. This construction resiliently clamps the cap at any position along the retainer between its fully-extended and fully-retracted positions.

Since the retainer and screw cap groove represent concentric circles, it is necessary that the clip configuration provide a sufficient difference between its lesser minor and greater major diameters to bridge the distance between the retainer and the cap. The sizing, geometric configuration and strength of the clip are selected so that the retainer can hold the capped screw in stable selected positions, which can be easily changed by applying a finger pull.

The invention provides an inexpensive yet effective panel fastener that has sufficient component stability to be successfully used with high speed assembly equipment. Furthermore, applicant's novel panel fastener permits the fastener to have a stay position in its free state which is selectable at any point along its range of motion.

### BRIEF DESCRIPTION OF THE DRAWINGS

FIG. 1 is a side elevation of a panel fastener in accordance with a preferred embodiment of the invention showing the cap and screw in a retracted position;

FIG. 2 is a side elevation of the panel fastener of FIG. 1 showing the cap and screw in an extended position;

FIG. 3 is a cross section of the panel fastener in the position shown in FIG. 1;

FIG. 4 is a cross section of the panel fastener in the position shown in FIG. 2;

FIG. 5 is a top plan view of the retainer clip seated in a groove formed between the retainer and cap of FIG. 1; and,

FIGS. 6, 7, and 8 are top plan views of retainer clips in accordance with alternative embodiments of the invention.

### DESCRIPTION OF THE PREFERRED EMBODIMENT

For the purpose of illustrating the invention, several preferred embodiments are shown in the accompanying drawings. However, it should be understood by those of ordinary skill in the art that the invention is not limited to the precise arrangements and instrumentalities shown therein and described below. Throughout the specification, like reference numerals are used to designate like elements. Numerous changes and modifications within the spirit and scope of the invention will become apparent to those skilled in the art from this detailed description. Unless otherwise defined, all terms used herein in their various grammatical forms have the same meaning as commonly understood by one of ordinary skill in the art to which this invention belongs.

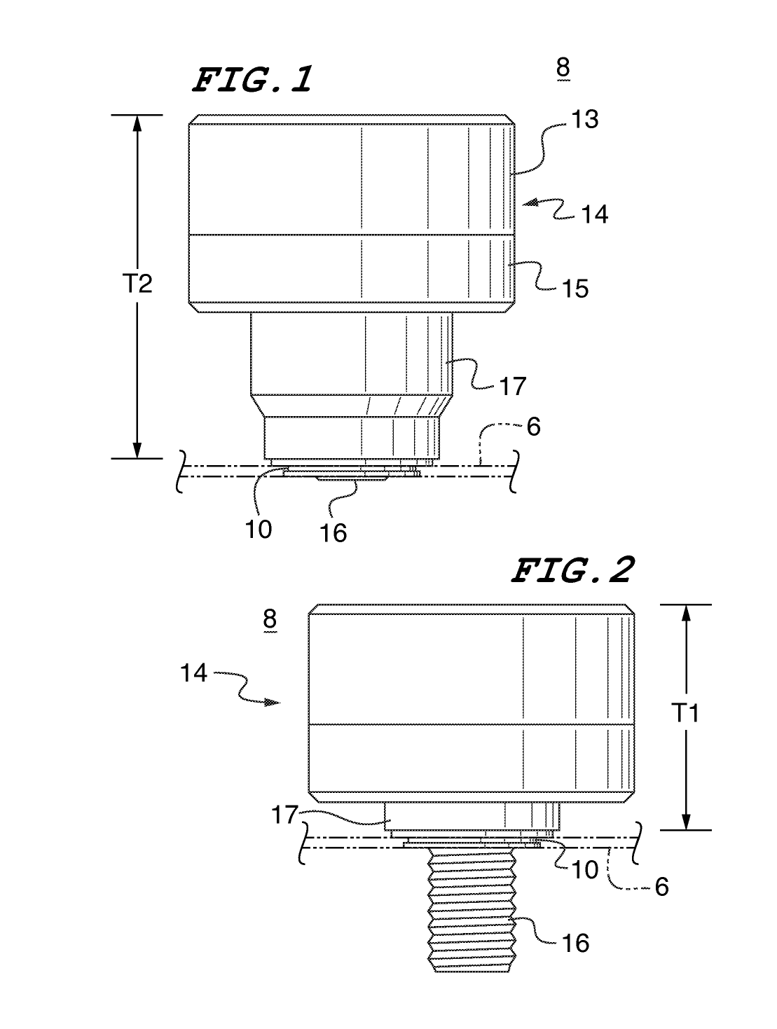

A panel fastener in accordance with a preferred embodiment of the invention is illustrated in FIGS. 1-5 and is designated generally by reference numeral 8. The panel fastener 8 generally comprises a screw 16, a screw cap 14, a retainer 17, and a clip 18. In one preferred embodiment, the cap 14 has a two-part construction comprising an upper portion 13 and lower portion 15, which are bonded together to form a unitary cap structure. The retainer 17 generally comprises a sleeve having a central, axial bore. With reference to the orientation shown in FIGS. 1-4, a clinch mechanism 10 is formed on the bottom end of the retainer 17 for clinching the retainer to a first top panel 6 in a manner known in the art.

The retainer 17 is designed to translate within the cap 14 between an extended position and a retracted position. The terms “retracted” and “extended” are used to describe configurations of the fastener with reference to the position of the cap 14 relative to a panel 6 to which the fastener 8 is cinched. Once installed on a panel 6, the bottom of the retainer 17 abuts the top surface of the panel 6. In FIG. 1, the cap 15 is shown in a retracted position away from the panel 6. In FIG. 2, the cap 15 is shown in an extended position close to the panel 6. In the retracted position, the top of the cap 14 protrudes a distance “T2” from the bottom of the retainer 17, which is equal to the protrusion distance from the top of the cap 14 to the panel 6. In the extended position show in FIG. 2, the cap 14 protrusion distance is reduced to a distance “T1”.

In a preferred embodiment, the screw 16 is fixed to the cap 14. In the extended position, the end of screw 16 extends from the bottom of the retainer 17 and through the panel 6. In this position, the screw 16 is then typically threaded into a receiving object such as a second bottom panel and tightened down. In other preferred embodiments, the screw 16 can be replaced with other forms of fasteners, both threaded and non-threaded, such as pins.

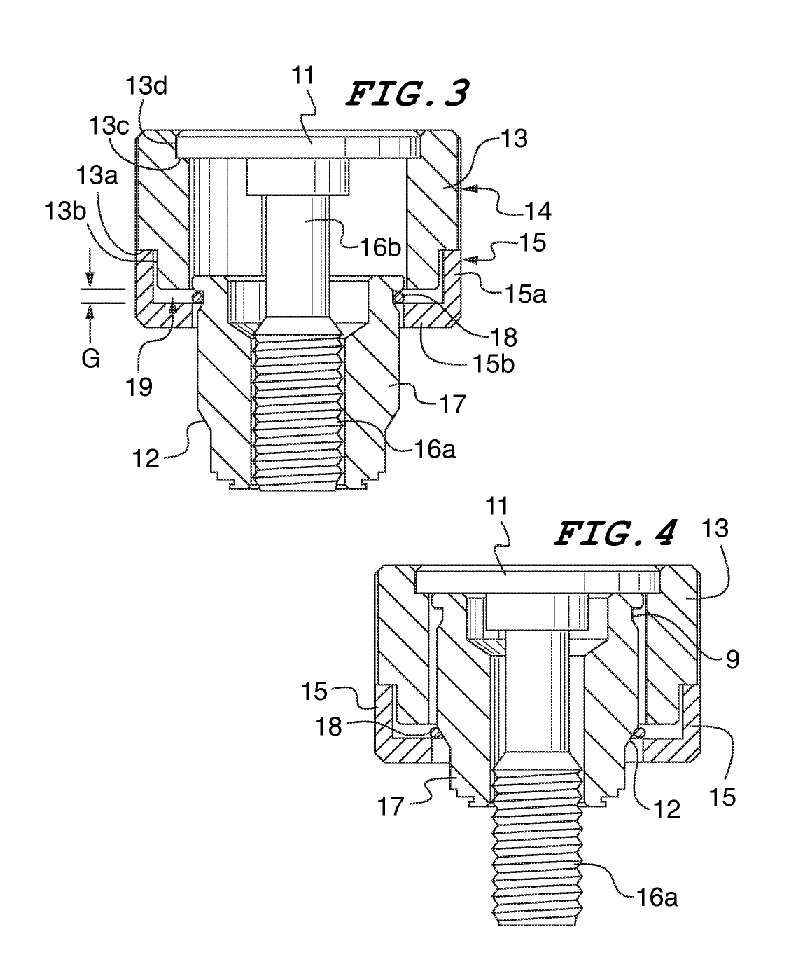

The internal components of the fastener 8 of this preferred embodiment are shown in FIGS. 3 and 4. The screw 16 includes a lower threaded portion 16a, an upper non-threaded position 16b, and a head 11. The cap 14 comprises an upper portion 13 and a lower portions 15, which are bonded together. In this preferred embodiment, the upper portion 13 comprises a generally-cylindrical sleeve having an axial bore. The upper portion 13 has a first shoulder 13a formed by a first annular notch (reduced-diameter-portion) in the lower, outer surface of the sleeve. The upper portion 13 has a second shoulder 13c formed by a second annular notch (reduced-diameter-portion) in the upper, inner surface of the sleeve. The lower portion 15 of the cap comprises an L-shaped ring having an axial-extending component 15a and a radially-extending component 15b. The axially-extending component 15a abuts and is fixed to the first shoulder 13a of the upper portion 13 of the cap. The overall outer diameter of the ring is equal to the outer diameter of the upper portion 13 of the cap, thereby forming a flush outer surface.

The screw 16 is rigidly affixed to the upper portion 13 of the cap. In a preferred embodiment, the head 11 of the screw 16 sits in the second notch with the underside of the head contacting the second shoulder 13c and the annular rim contacting the reduced-diameter portion 13d of the notch.

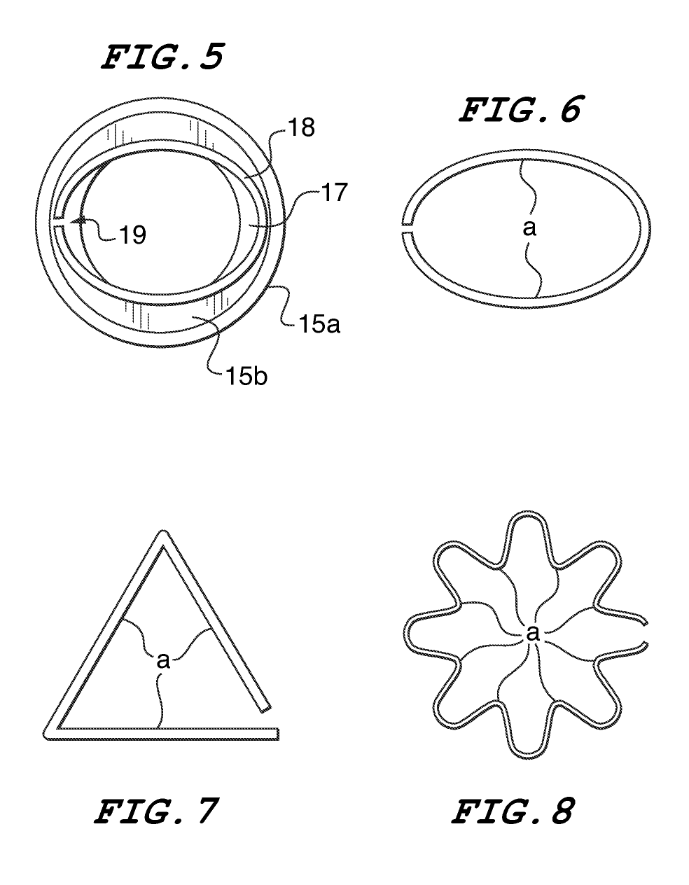

The cap has a downwardly-extending skirt that surrounds a retainer. The axial component 15a of the lower cap portion is of sufficient length to form an internal gap “G” between the bottom of the upper portion 13 of the cap 14 and the radial component 15b of the lower portion 15 after the two cap portions are joined. This gap creates a groove 19 along the inner wall of the cap in which portions of clip 18 are seated as depicted in FIG. 5. The axial component 15a of the lower portion 15 defines the radial boundary of the groove 19.

In a preferred embodiment, the clip 18 is non-circular and has a major outside dimension and a minor inside dimension measured from the center of the clip as shown by the examples presented in FIGS. 5-8. The clip 18 is preferably composed of resilient material such as spring steel. With reference to the plane of view shown in FIGS. 5-8, the clip 18 is configured to have a free (relaxed) minor inside diameter less than the diameter of the retainer 17. Hence, the inside edges of the clip 18 frictionally grasp the outer surface of the retainer 17 and inhibit axial translation of the cap 14 (and screw 16) relative to the retainer 17.

The outer surface of the retainer 17 includes contours and regions of reduced diameter over which frictional resistance by the clip is increased to further enable axial translation of the cap. In this preferred embodiment, the retainer 17 includes a proximal (relative to the screw head) annular reduced-diameter region 9 and a distal annular reduced-diameter region 12 near the proximal and distal axial ends, respectively, of the sleeve, in which the clip sits when the fastener is configured in the retracted and extended positions, respectively. In this embodiment, the proximal reduced-diameter position 9 comprises an annular groove in the outer surface while the distal position 12 comprises a frustoconical profile on the outer surface of the sleeve 17. These reduced-diameter regions 9, 12 provide a position of greater resistance to axial movement of the cap/screw, thus enhancing the fastener's positional stability at that those locations. In other embodiments, the reduced-diameter regions 9, 12 could be the same, or could have completely different profiles than shown in FIGS. 3 and 4.

In the retracted position shown in FIG. 3, the clip 18 is seated in the proximal region 9 around the top of the retainer 17. As the fastener translates from the retracted position to the extended position shown in FIG. 4, the cap/screw assembly translates axially over the retainer 17 until the underside of the head 11 contacts the proximal rim of the sleeve. In the extended position, the clip 18 has moved from the groove 9 to the frustoconical area 12. By the wedging effect of the clip 18 clamping against the retainer 17 in this area, a downward force is applied to the cap 14 and screw 16. This downward force can be sufficient to overcome the biasing force of an internal spring applied to the fastener in the opposite direction if a spring is used as is often the case. The combined effect of these spatial relationships is to hold the screw and retainer in a condition of compact stability. This degree of stability with the fastener held in the extended position meets the requirements of the pick-and-place robotics used in the electronics industry. Notably, this is achieved without the use of additional sacrificial elements employed in the prior art.

Referring now to FIG. 5, the lower cap portion 15 and clip 18 are seen in isolation from above. The panel fastener can be assembled by first placing the clip 18 in the groove 19 area of the lower portion 15 of the cap 14 before the cap sections 13, 15 are bonded together. In this embodiment, the clip 18 is elliptical and has an outer major dimension portion that extends almost to the inner wall of the axial portion 15a of the lower portion 15 of the cap 14. Once the upper and lower portions 13, 15 of the cap are bonded together and form the groove 19, these major-dimension portions of the clip 18 remains seated deeply in the groove 19. Preferably, the diameter, or thickness if the clip is not round, closely approximates the size of the gap “G” so that the clip is held securely within the groove and has very limited axial freedom.

FIGS. 6, 7 and 8 show additional preferred embodiments of the clip 18. These geometric configurations are elliptical, triangular and star-shaped, respectively. The configuration and material of the clips are selected to provide a constant resilient radially inward force against the retainer 17, which is acted upon by the portion of the clip “a” having a minor dimension.

The embodiments of the invention described above provide a panel fastener with stable static screw positioning that is easily adjustable and repeatable. The present panel fastener can be used in different panel designs where the cap has a clearance problem with another panel or other parts before the screw is tightened. It also can be used in SMT (surface mount technology) applications, which require stability for an automated pick-and-place process. Although the embodiments illustrated utilize a screw as the fastener, the above-described mechanical relations may be equally applied to other fasteners such as an unthreaded pin or other fasteners with other means of second panel attachment.

The foregoing should be considered as illustrative only of some embodiments of the invention. Further, since numerous modifications and changes will readily occur to those skilled in the art, it is not desired to limit the invention to the exact construction and operation shown and described, and accordingly, all suitable modifications and equivalents may be resorted to, all falling within the scope of the invention, which should be determined only by the following claims and their legal equivalents.

What is claimed is:

1. A panel fastener, comprising:
a fastener affixed to a surrounding cap, said cap having a downwardly extending peripheral portion which includes an inner wall;
a groove located along the cap inner wall;
a non-circular resilient clip residing partly within said groove; and,
a retainer having a bore through which a shank of said fastener is axially moveable between retracted and extended positions;
wherein portions of the clip frictionally engage the retainer which prevents the fastener from moving freely axially within the retainer.

2. The panel fastener of claim 1 wherein the cap is composed of two parts bonded together to form the groove which is defined by a partial gap between the two parts.

3. The panel fastener of claim 2 wherein the outside of the retainer includes regions of reduced diameter that are engagable by the clip.

4. The panel fastener of claim 3 wherein the fastener further includes a head having a bottom surface which abuts the retainer when the fastener is in the extended position.

5. The panel fastener of claim 3 wherein the clip is elliptical.

6. The panel fastener of claim 3 wherein the clip is triangular.

7. The panel fastener of claim 3 wherein the clip is star shaped.

8. The panel fastener of claim 1 wherein the portions of the clip that engage the retainer are located along an inside edge of the clip of a lesser minor diameter than other portions of the clip which are of a greater major diameter.

9. The panel fastener of claim 2 wherein said cap parts comprise an upper portion and a lower portion, said lower portion being a ring of L-shaped cross-section.

10. The panel fastener of claim 9 wherein the groove is radially bounded by a vertical component of the lower portion of the cap which defines an outer wall of the groove.

11. The panel fastener of claim 3 wherein a region of the retainer of reduced diameter is a frustoconical region whereby a clamp force applied by the clip against the frustoconical region of the retainer biases the fastener downwardly relative to the retainer.

12. The panel fastener of claim 11 wherein the fastener is in the extended position when the clip is engaged with the frustoconical region.

13. The panel fastener of claim 9 wherein the gap is located between a bottom of the upper portion of the cap and a horizontal component of the lower portion of the cap.

14. The panel fastener of claim 1 wherein a bottom end of the retainer includes means for attachment to a panel.

15. The panel fastener of claim 14 wherein the fastener is a screw having a threaded end for engagement with a second panel.
